(19) United States
(12) Patent Application Publication
(10) Pub. No.: US 2011/0016102 A1
(43) Pub. Date: Jan. 20, 2011

(54) System and method for identifying and providing user-specific psychoactive content

(76) Inventors: Louis Hawthorne, Mill Valley, CA (US); d'Armond Lee Speers, Thornton, CO (US); Michael Renn Neal, Arvada, CO (US); Abigail Betsy Wright, Longmont, CO (US)

Correspondence Address: Goodwin Procter LLP;Attn: Patent Administrator, 135 Commonwealth Drive, Menlo Park, CA, 94025-1105, US

(21) Appl. No.: 12/460,522

(22) Filed: Jul. 20, 2009

(51) Int. Cl. G06F 7/10; G06F 17/30

(52) U.S. Cl. 707/706; 707/E17.108; 707/E17.009

(57) ABSTRACT

A new approach is proposed that contemplates systems and methods to identify, select, and present psychoactive content to a user in order to achieve a desired psychotherapeutic effect or purpose on the user. More specifically, content items in a content library are tagged and categorized under various psychoactive properties. In addition, image-feeling associations are assessed on a per user basis to determine what types of content items induce what types of feelings/reactions from the specific user. A content comprising one or more content items can then be presented to the user based on its ability to induce a desired shift in the emotional state of the user.

### RELATED APPLICATIONS

This application is related to U.S. Ser. No. 12/476,953 filed Jun. 2, 2009, which is a continuation-in-part of U.S. Ser. No. 12/253,893, filed Oct. 17, 2008, both of which applications are fully incorporated herein by reference.

### BACKGROUND

With the growing volume of content available over the Internet, people are increasingly seeking content online as part of their multimedia experience (MME) not only for useful information to address his/her problem, but also to have the benefit of an emotional experience. Here the content may include one or more of, a text, an image, a video or audio clip. The content that impacts a viewer/user emotionally can be psychoactive (psyche-transforming) in nature, i.e., the content may be beautiful, sensational, even evocative, and thus may induce emotional reactions from the user.

It has been taken for granted by media professionals, particularly in the advertising field, that imagery and montage can have psychoactive properties and impact on a user. Vendors of online content in various market segments that include but are not limited to advertising, computer games, leadership/management training, and adult education, have been trying to provide psychoactive content in order to elicit certain emotions and behaviors from users. However, it is often hard to identify, select, and tag psychoactive content to achieve the desired psychotherapeutic effect or purpose on a specific user. Although some online vendors do keep track of web surfing and/or purchasing history or tendency of an online user for the purpose of recommending services and products to the user based on such information, such online footprint of the user does not truly reflect the emotional impact of the online content on the user. For a non-limiting example, the fact that a person purchased certain books as gifts for his/her friend(s) is not indicative of the emotional impact of the book may or may not have on him/herself.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 depicts an example of a system diagram to support identifying and providing user-specific psychoactive content.

FIG. 2 illustrates an example of various types of content items and the potential elements in each of them.

FIGS. 3(a)-(f) show examples of images with various inherent properties.

FIG. 4 shows an example of an image where there are light greens, dark greens, and an assortment of other colors.

FIG. 5 depicts a flowchart of an example of a process to algorithmically detect a color profile in an image under k-means clustering approach.

FIGS. 6(a)-(c) depict a pixel selection grid used for identifying a centroid in a color space.

FIG. 7 depicts an example of a three-dimensional vector space formed with each color positioned within the space based on its RGB value.

FIGS. 8(a)-(c) show examples of distributions of pixels to clusters.

FIGS. 9(a)-(b) depict examples of images used for user-specific content-feeling associations.

FIG. 10 depicts an example of visual representation of emotions.

FIG. 11 depicts a flowchart of an example of a process to support identifying and providing user-specific psychoactive content.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to identify, select, and present psychoactive content to a user in order to achieve a desired psychotherapeutic effect or purpose on the user. More specifically, content items in a content library are tagged and categorized under various psychoactive properties. In addition, image-feeling associations are assessed on a per user basis to determine what types of content items induce what types of feelings/reactions from the specific user. A script of content (also known as a user experience, referred to hereinafter as “content”) comprising one or more content items can then be presented to the user based on its ability to induce a desired shift in the emotional state of the user. With the in-depth knowledge and understanding of the psychoactive properties of the content and the possible emotional reactions of a user to such content, an online vendor is capable of identifying and presenting the “right kind” of content to the user that specifically addresses his/her emotional needs at the time, and thus provides the user with a unique emotional experience that distinguishes it from his/her experiences with other types of content.

A content referred to herein can include one or more content items, each of which can be individually identified, retrieved, composed, and presented to the user online as part of the user's multimedia experience (MME). Here, each content item can be, but is not limited to, a media type of a (displayed or spoken) text (for a non-limiting example, an article, a quote, a personal story, or a book passage), a (still or moving) image, a video clip, an audio clip (for a non-limiting example, a piece of music or sounds from nature), and other types of content items from which a user can learn information or be emotionally impacted. Here, each item of the content can either be provided by another party or created or uploaded by the user him/herself.

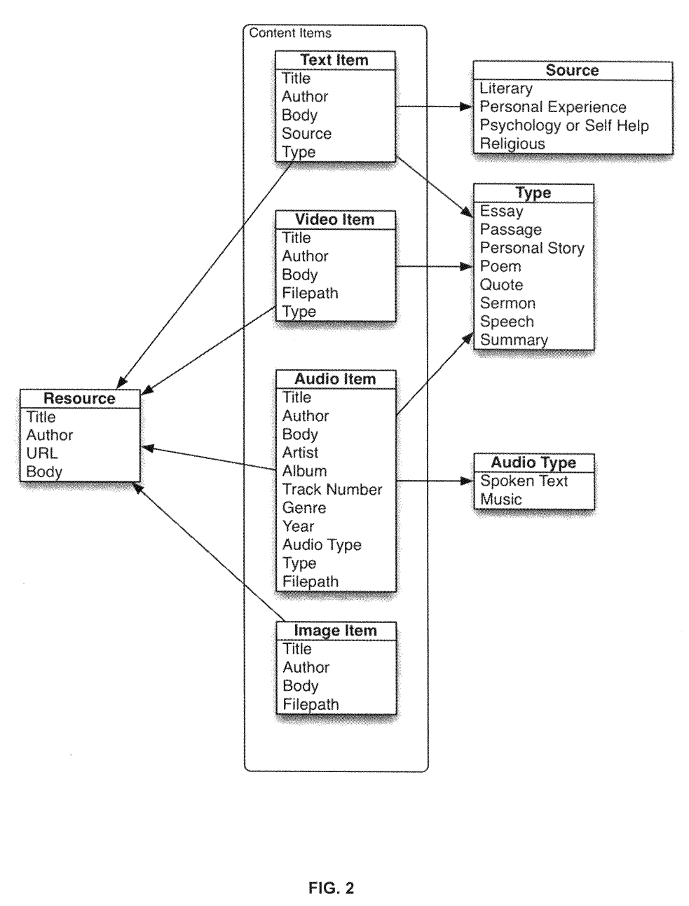

In some embodiments, each of a text, image, video, and audio item can include one or more elements of: title, author (name, unknown, or anonymous), body (the actual item), source, type, and location. For a non-limiting example, a text item can include a source element of one of literary, personal experience, psychology, self help, spiritual, and religious, and a type element of one of essay, passage, personal story, poem, quote, sermon, speech, and summary. For another non-limiting example, a video, an audio, and an image item can all include a location element that points to the location (e.g., file path or URL) or access method of the video, audio, or image item. In addition, an audio item may also include elements on album, genre, or track number of the audio item as well as its audio type (music or spoken word). FIG. 2 illustrates an example of various types of content items and the potential elements in each of them.

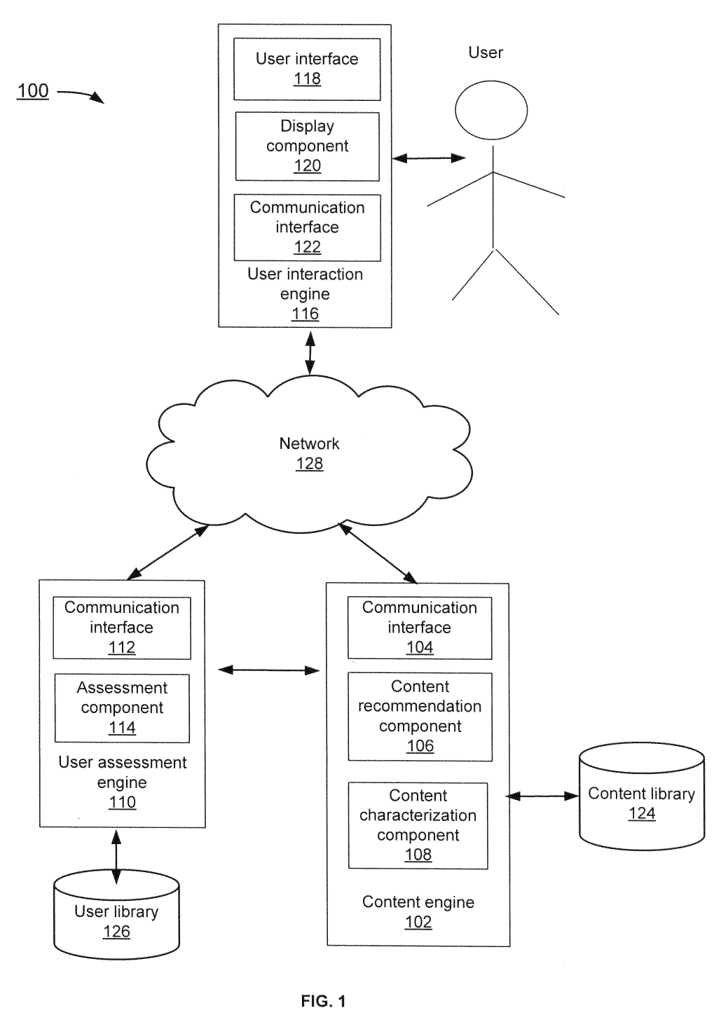

FIG. 1 depicts an example of a system diagram to support identifying and providing user-specific psychoactive content. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a content engine 102, which includes at least a communication interface 104, a content recommendation component 106, and a content characterization component 108; a user assessment engine 110, which includes at least a communication interface 112 and an assessment component 114; a user interaction engine 116, which includes at least a user interface 118, a display component 120, and a communication interface 122, a content library (database) 124 coupled to the content engine 102, a user library (database) 126 coupled to the user assessment engine 110, and a network 128.

As used herein, the term engine refers to software, firmware, hardware, or other component that is used to effectuate a purpose. The engine will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

As used herein, the term library or database is used broadly to include any known or convenient means for storing data, whether centralized or distributed, relational or otherwise.

In the example of FIG. 1, each of the engines and libraries can run on one or more hosting devices (hosts). Here, a host can be a computing device, a communication device, a storage device, or any electronic device capable, of running a software component. For non-limiting examples, a computing device can be but is not limited to a laptop PC, a desktop PC, a tablet PC, an iPod, a PDA, or a server machine. A storage device can be but is not limited to a hard disk drive, a flash memory drive, or any portable storage device. A communication device can be but is not limited to a mobile phone.

In the example of FIG. 1, the communication interface 104, 112, and 118 are software components that enable the content engine 102, the user assessment engine 110, and the user interaction engine 116 to communicate with each other following certain communication protocols, such as TCP/IP protocol. The communication protocols between two devices are well known to those of skill in the art.

In the example of FIG. 1, the network 128 enables the content engine 102, the user assessment engine 110, and the user interaction engine 116, to communicate and interact with each other. Here, the network 128 can be a communication network, based on certain communication protocols, such as TCP/IP protocol. Such a network can be but is not limited to, Internet, intranet, wide area network (WAN), local area network (LAN), wireless network, Bluetooth, WiFi, and mobile communication network. The physical connections of the network and the communication protocols are well known to those of skill in the art.

In the example of FIG. 1, the content library 124 maintains content items as well as definitions, tags, and resources of the content. The content library 124 may serve as a media “book shelf” that includes a collection of content items as well as various kinds of psychoactive properties of the content items that can be used to meet a user's emotional need. The content engine 102 may retrieve content items either from the content library 124 via content recommendation component 106 of the content engine 102 or, in case the content items relevant are not available there, identify the content items with the appropriate psychoactive properties over the Web and save them in the content library 124 so that these content items will be readily available for future use.

In the example of FIG. 1, the content characterization component 108 of the content engine 102 identifies, tags, and categorizes the content items in the content library 124 based on the psychoactive effects associated with at least one or more of the inherent (psychoactive) properties of each of the content items. It is also possible that an expert in the field may manually tag one or more of the content items. For a non-limiting example, the image of a simple bottle of water, depending on properties ranging from color, lighting, shape, position and, of course, context, the image may elicit in the user a wide assortment of emotions from excitement to desire to transcendence. Although images are used as non-limiting examples in the discussions hereinafter, similar characterization can be applied to other types of content items that may have a psychoactive effect on a user. The inherent properties of the content items that may evoke psychoactive feelings include but are not limited to:

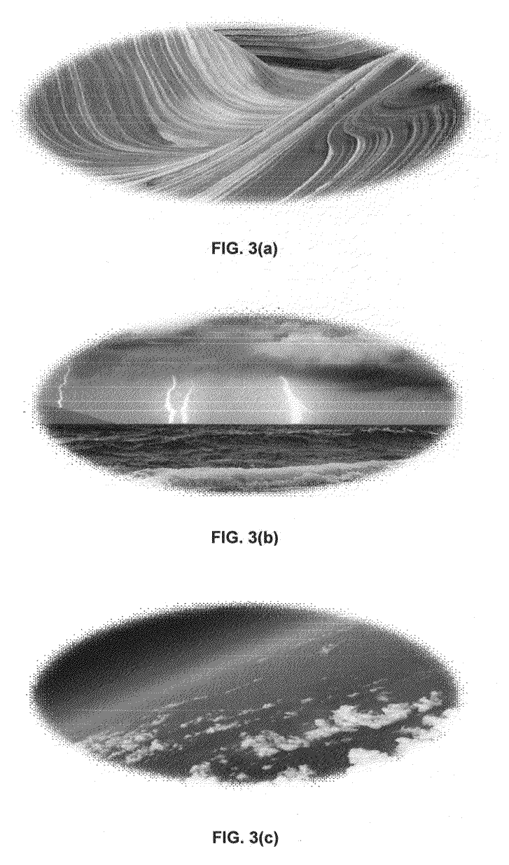

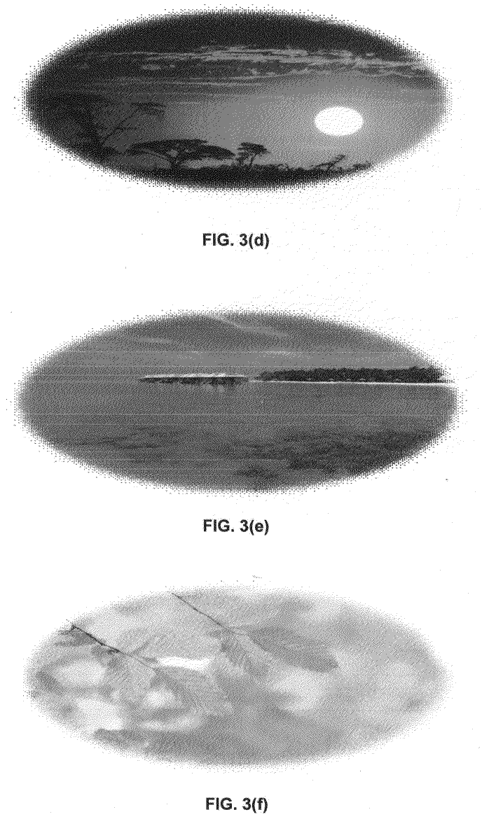

Abstractness (Concrete vs. Abstract)—Images rendered more for form than content naturally tend to decrease the significance of the content of the image and increase the significance of the form (i.e., other image properties). In addition, more abstract images may allow the user to project his/her feelings and imagination onto the specific image and the MME as a whole more readily than more concrete images. FIG. 3(a) shows an example of an image with a high Abstractness rating (though one can still identify the image).

Energy (Static vs. Kinetic)—An image of an ocean can be calm or raging; FIG. 3(b) shows an example of an ocean image with a very high Energy rating.

Scale (Micro vs. Macro)—Whether an image is shot from an extreme macro point of view (POV) such as high above Earth or from outer space or in extreme close-up such as of the stamen of a flower, both have distinct effects on viewer's mood. FIG. 3(c) shows an example of an image would have a high “Scale” rating.

Time of day (Dawn through Night)—Time of day strongly affects the mood of an image. FIG. 3(d) shows an example of an image that would be about 75% on a Dawn-to-Night scale.

Urbanity (Urban to Natural)—Many images are a blend of both man-made and natural elements, and the precise ratio can elicit a unique response. FIG. 3(e) shows an example of an image with high ratio of natural elements.

Season (Summer, Fall, Winter, Spring)—The same scene elicits different reactions when embellished with flowers vs. snow. Seasons can be selected by radio button or check box rather than slider when tagged manually. FIG. 3(f) shows an example of an image that could be checked for both Summer and Fall.

Facial expressions and depictions of behavior—There is an entire class of psychoactive image properties pertaining to the presence within the image of facial expressions (such as happy, sad, angry, etc.) or depictions of behavior (such as kindness, cruelty, tenderness, etc.). Both the expressions and the behaviors can be rapidly categorized via a custom screen built using emotive icons.

Note that the content characterization component 108 can tag multiple properties, such as Abstract, Night, and Summer, on a single content item for the purpose of easy identification and retrieval.

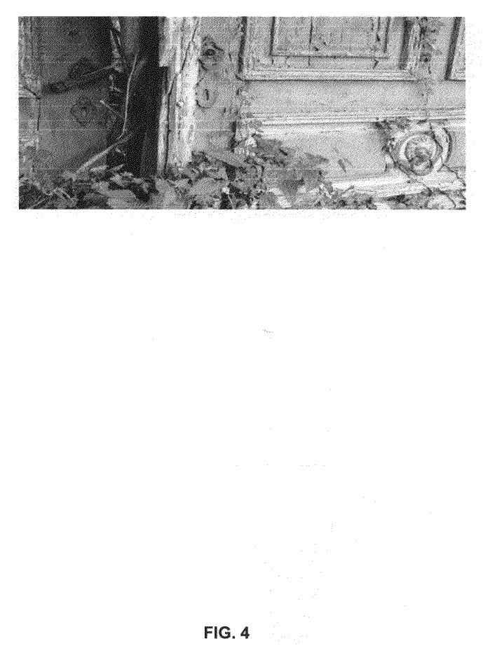

In some embodiments, the content characterization component 108 of the content engine 102 identifies/detects a color profile and/or brightness of an image algorithmically, as colors and how light or dark an image is affects a user's mood dramatically, such as a painting whose dark scenes are sometimes punctuated by a single candle's light. In one embodiment, the content characterization component 108 uses the identified color profile as an index to a table of predefined “dark” and “bright” color values to select images from the content library for desired effect on the user. Here, the color profile is defined as the set of RGB values that occur most frequently in an image. In most occasions, it is insufficient to simply count the number of times each color appears in an image and pick a winner. FIG. 4 shows an example of an image where there are light greens, dark greens, and an assortment of other colors (i.e., browns or oranges). The human perception of this image is that its most frequent color is green. However, simply counting the frequency with which each color is used yields a counter-intuitive result, that the most frequent color is brown. What is needed is an approach that recognizes that all the different shades of green are similar, and that the collection of these similar colors is greater than the collections of other similar colors.

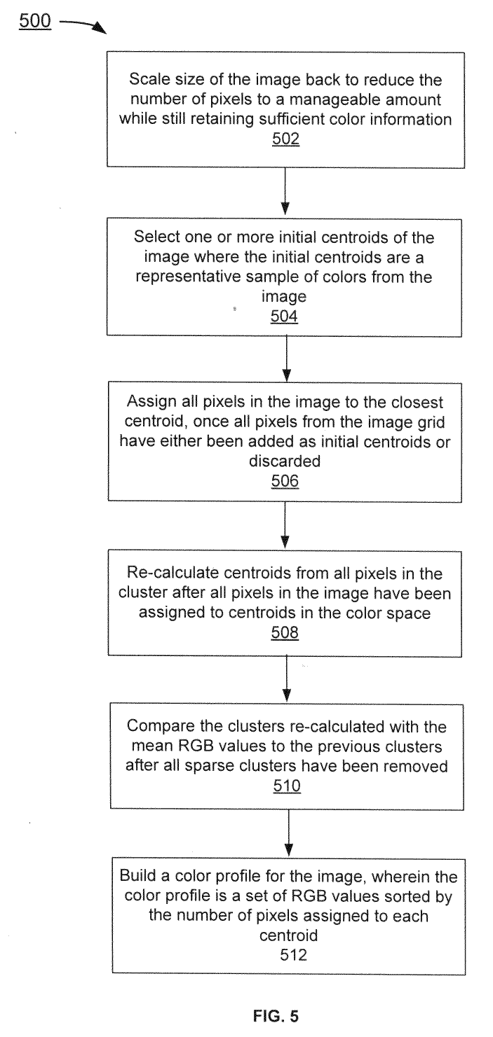

FIG. 5 depicts a flowchart of an example of a process to algorithmically detect a color profile in an image under k-means clustering approach. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 5, the flowchart 500 starts at block 502 where size of the image is scaled back to reduce the number of pixels to a manageable amount while still retaining sufficient color information. In some embodiments, the content characterization component 108 scales the image so that the longer dimension (either width or height) is no larger than 150 pixels, and the shorter dimension maintains the aspect ratio. The maximum number of pixels in the image is thus 22,500, with a typical image containing about 15,000 pixels.

In the example of FIG. 5, the flowchart 500 continues to block 504 where one or more initial centroids of the image are selected, where the initial centroids should be a representative sample of colors from the image. To determine the frequency of colors in the image, the content characterization component 108 first groups together pixels that have a similar color. Such group of pixels is called a cluster, the center of a cluster is called a centroid, and grouping items (such as pixels) based on similar features is called clustering. After pixels are assigned to a cluster, the centroid can be calculated from the color values of the pixels. But in order to initialize the clustering, an initial set of centroids must be created.

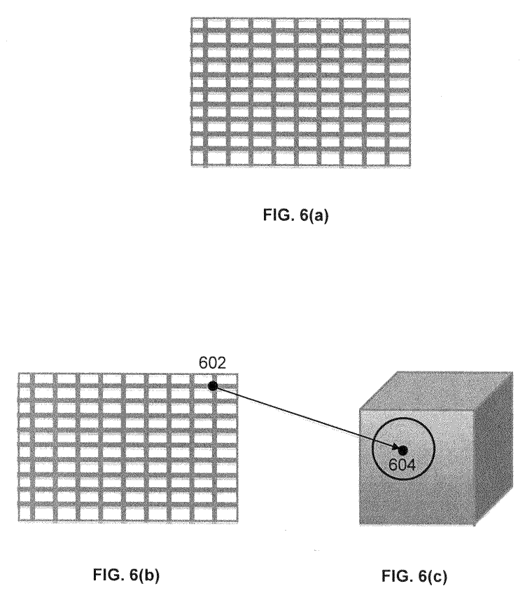

In some embodiments, the content characterization component 108 adopts the k-means clustering approach, which defines a set of k clusters, where the centroid of each cluster is the mean of all values within the cluster. In some embodiments, the content characterization component 108 starts by building a grid over the image, with each vertical and horizontal line spaced at 1/10^{th} of the image size, as shown in FIG. 6(a). The content characterization component 108 samples the pixels at the intersection of the horizontal and vertical lines. For each pixel, the content characterization component 108 only adds it to the set of initial centroids if it is sufficiently distant from all other initial centroids according to the distance from each candidate centroid to all current centroids. For a non-limiting example, FIG. 6(b) shows a pixel 602 from the image, and FIG. 6(c) shows an existing centroid 604 in the color space. The threshold distance around the centroid 604 is shown as a black circle around the centroid. The RGB value for that pixel becomes a candidate centroid in the color space. To determine whether to add the RGB value as a centroid, the content characterization component 108 checks to see if there are any existing centroids within a set distance of that value. For each existing centroid in the color space, the content characterization component 108 calculates the distance from the candidate centroid to the existing centroid, using the Euclidean distance measure as discussed below. If no centroids have a distance<threshold, the content characterization component 108 adds the candidate as a new centroid, otherwise it skips that pixel.

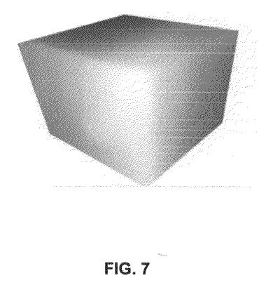

In the example of FIG. 5, the flowchart 500 continues to block 506 where all pixels in the image are assigned to the closest centroid, once all pixels from the image grid have either been added as initial centroids or discarded. In order to assign pixels with similar colors to clusters, the content characterization component 108 first determines what it means for one color to be “similar” to another color. In some embodiments, the content characterization component 108 computes similarities between sets of data with multiple dimensions by plotting the values for these dimensions of each set in n-dimensional vector space, where n is the number of dimensions to be compared. In the case of a color image, the color of a pixel is a combination of values for red, green, and blue, referred to as RGB, with each value in the range of 0-255. An example of a three-dimensional vector space referred to herein as color space as shown in FIG. 7 can be formed with red on the x-axis, green on the y-axis, and blue on the z-axis, with each color positioned within the color space based on its RGB value. Once the color space is formed, how similar two colors are to each other can be expressed as the Euclidean distance between two vectors in the color space, wherein the Euclidean distance between two values RGB₁ and RGB₂ can be calculated as:

d=\sqrt{(r₁−r₂)²+(g₁−g₂)²+(b₁−b₂)²}

Two colors with a lower value of d (a shorter distance) are more similar than two colors with a larger value of d (a greater distance). For each pixel in the image, the content characterization component 108 obtains its RGB value and computes a distance value d from that pixel to each centroid in the color space. The pixel is assigned to the centroid with the shortest distance (i.e., the nearest centroid).

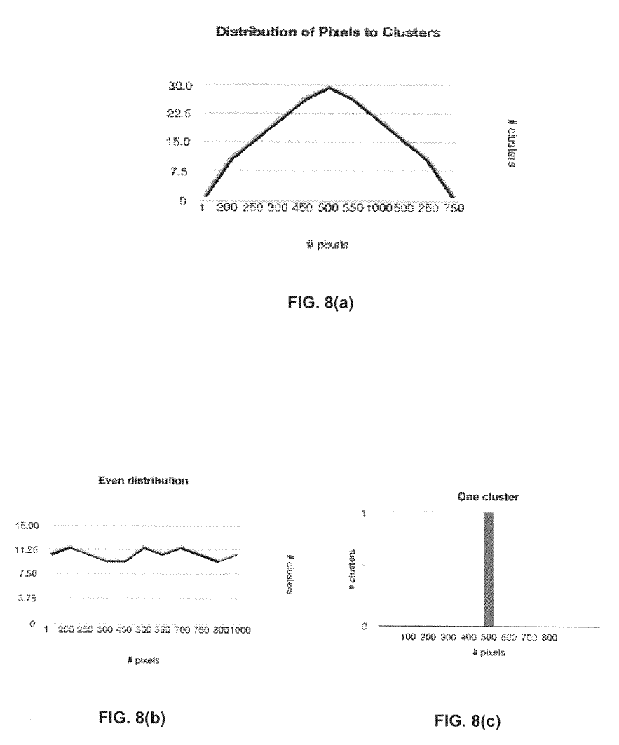

In the example of FIG. 5, the flowchart 500 continues to block 508 where centroids from all pixels in the cluster are re-calculated after all pixels in the image have been assigned to centroids in the color space. The new centroid of each cluster can be calculated as the average RGB value for all pixels in the cluster. In addition, a centroid with few pixels assigned to it can be removed from consideration. FIG. 8(a) shows a plot of centroids against the number of pixels assigned to the centroids, resulting in a graph resembling the normal distribution. To determine the threshold number of pixels below which a centroid can be removed, the content characterization component 108 may calculate the standard deviation sd of pixels to clusters, and remove any clusters that have fewer than max−z×sd pixels, where max is the maximum number of pixels in a cluster, z=5 and max−z×sd>0. FIGS. 8(b)-(c) show examples of other distributions of pixels to clusters.

In the example of FIG. 5, the flowchart 500 continues to block 510 where the clusters re-calculated with the mean RGB values are compared to the previous clusters after all sparse clusters have been removed. If any pixels have changed the cluster they are assigned to, or if any cluster has changed its centroid, then blocks 506-508 will be repeated iteratively until all pixels are assigned to a cluster, no pixels change which cluster they are assigned to, and no cluster changes its centroid.

In the example of FIG. 5, the flowchart 500 ends at block 512 where the remaining centroids are arranged in a color profile for the image, wherein the color profile is a set of RGB values and weights sorted by the number of pixels assigned to each centroid. Here, each weight describes the percentage coverage of the image that this color represents, as x/n, where x=the number of pixels in the cluster and n=the total number of pixels sampled from the image. Back to the example of FIG. 4 of green vines on a door (above), the color detection approach described in FIG. 5 creates the following color profile:

| | Weight | RGB | Color name |
|---|---|---|---|
| 1 | .23 | 191-202-186 | light purplish gray |
| 2 | .23 | 135-152-135 | grayish yellow green |
| 3 | .18 | 112-105-85 | grayish green |
| 4 | .17 | 61-78-47 | grayish green |
| 5 | .08 | 0-0-0 | black |
| 6 | .03 | 244-241-224 | yellowish white |
| 7 | .03 | 189-123-79 | light reddish brown |
| 8 | .02 | 124-64-35 | grayish green |

In some embodiments, the content characterization component 108 identifies a color name for the detected colors, using the same distance measure as used in the k-means clustering discussed above. There are about 16.7 million colors in the color space (256³) and there is no standard mapping of color names to all possible RGB values. In some embodiments, the content characterization component 108 uses a set of color names taken from an extended HTML color set and finds the closest named color for the identified RGB values. Although the closest-named color may not be a strong match to the perception of the actual color because there are so few color names for determining whether two images have a similar color profile, however, the actual RGB values of the color are used, not the RGB value of the nearest named color.

In the example of FIG. 1, the assessment component 114 of the user assessment engine 110 assesses content-feeling associations on a per user basis to determine what types of content items induce what types of feelings/reactions in a specific user. Performing such assessment on the specific user is important for user-specific psychoactive content generation, since even after the content characterization component 108 of content engine 102 identifies and categorizes content items in the content library 124 by potential psychoactive properties accordingly, it is still necessary to determine how a given combination of psychoactive properties will affect the user's psyche.

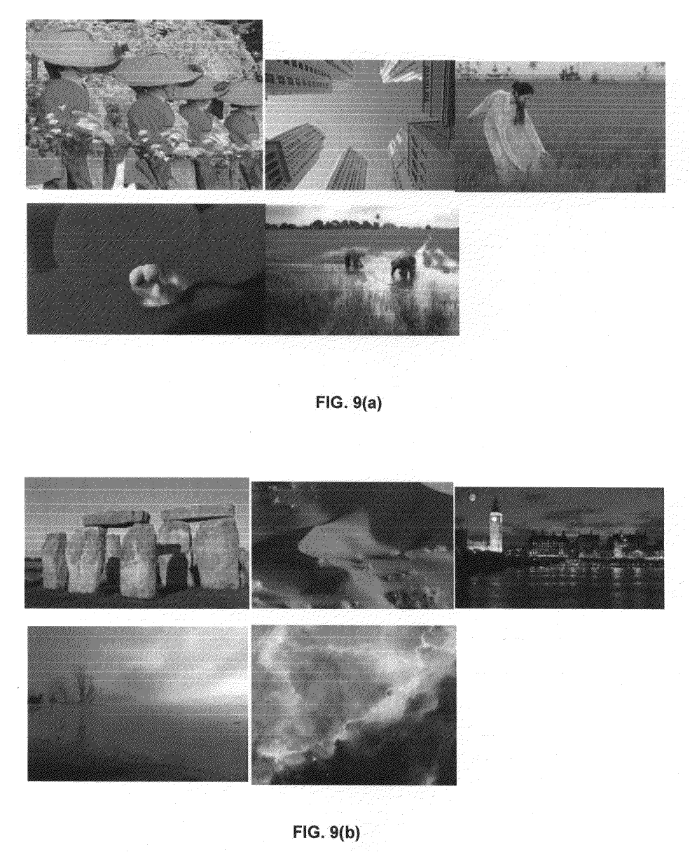

In some embodiments, the user assessment engine 110 presents the user with one or more content items, such as images, preceded by one or more questions regarding the user's feeling towards the images via the display component 120 of user interaction engine 116 for the purpose of soliciting and gathering at least part of the information needed to assess the types of feelings/reactions of the user to content items with certain psychoactive properties. Here, each image presented to the user has a specific (generally unique) combination of potentially psychoactive properties, and to the extent the user provides honest answers about what he or she is feeling when viewing each image during the image/feeling association assessment, the assessment engine 110 may be able to induce similar feelings during future content presentations by including images with substantially similar psychoactive property values. The initial content-feeling association assessment can be fairly short—perhaps 5-6 questions/image sets—ideally at the user's registration. If necessary, the assessment engine 110 can recommend additional image/feeling assessments at regular intervals, such as once per user log-in. Here, the questions preceding the images may focus on the user's emotional feelings towards certain content items. For a non-limiting example, such question can be “which image makes you feel most peaceful?”—followed by a set of images, which may then be followed by another question and another set of images to probing a different image/feeling association. For non-limiting examples, FIG. 9(a) shows an example of a set of images preceded by the question “which image makes you feel most energized?”, and FIG. 9(b) shows another example of a set of images preceded by the question “which image makes you feel most safe?”

The process of iterative question-image set probing described above is quick, perhaps even fun for some users, and it can be repeated as many times as necessary for the assessment engine 110 to build increasingly effective associations between psychoactive properties of a group of content items and associated emotional inductions (e.g., peaceful, excited, loved, hopeful, etc.) of that specific user. Once established, the content-feeling associations of the specific user can be maintained in a user library 126 for management and later retrieval.

In some embodiments, the assessment component 114 of the assessment engine 110 also assesses the current emotional state of the user before any content is retrieved and presented to the user. For non-limiting examples, such emotional state may include but is not limited to, Love, Joy, Surprise, Anger, Sadness, or Fear, each having its own set of secondary emotions. The assessment of the user's emotional state is especially important when the user's emotional state lies at positive or negative extremes, such as joy, rage, or terror, since it may substantially affect content-feeling associations and the psychoactive content to be presented to the user—the user apparently would look for different things depending upon whether he/she is happy or sad.

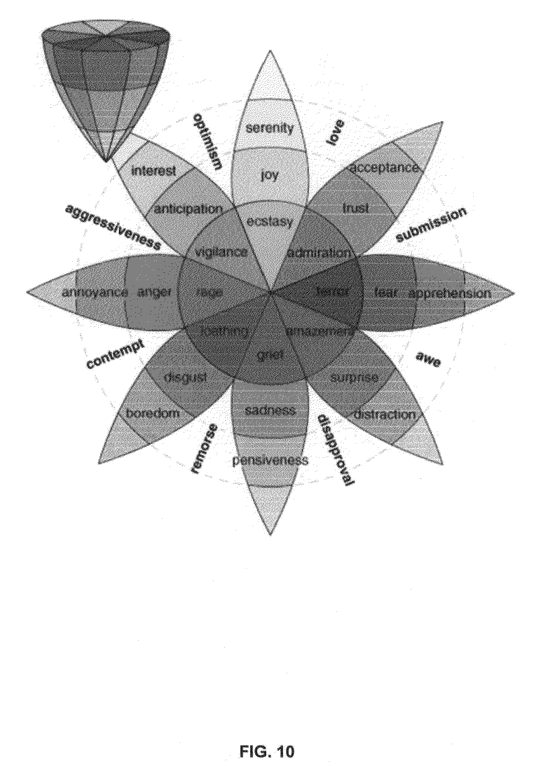

In some embodiments, the assessment engine 110 may initiate one or more questions to the user via the user interaction engine 116 for the purpose of soliciting and gathering at least part of the information necessary to assess the user's emotional state. Here, such questions focus on the aspects of the user's life and his/her current emotional state that are not available through other means. The questions initiated by the assessment engine 110 may focus on the personal interests and/or the spiritual dimensions of the user as well as the present emotional well being of the user. For a non-limiting example, the questions may focus on how the user is feeling right now and whether he/she is up or down for the moment, which may not be truly obtained by simply observing the user's past behavior or activities. In some embodiments, the profile engine 110 may present a visual representation of emotions, such as a three-dimensional emotion circumplex as shown in FIG. 10, to the user via the user interaction engine 102, and enables the user to select up to three of his/her active emotional states by clicking on the appropriate regions on the circumplex or the color wheel.

In some embodiments, in order to gather responses based on the current state of mind of the user, the user assessment engine 110 may always perform an emotional state and an emotional-state-specific content-feeling association assessment of the user whenever psychoactive content is to be retrieved or presented to the user. Such assessment aims at identifying the user's emotional state as well as his/her content-feeling associations at the time, and is especially important when the user's emotional state lies at positive or negative extremes. For a non-limiting example, the user may report that a certain image is exciting in one state of mind, but not in another state of mind. Thus, different kinds of psychoactive content may need to be recommended and retrieved for the user depending upon whether he/she is currently happy or sad. The user assessment engine 110 may then save the assessed content-feeling associations in the user library 126 together with the user's emotional state at the time.

In some embodiments, the user assessment engine 110 may perform content-feeling association assessments on a regular basis in order to assess an emotional-state-neutral, instead of emotional-state-specific, content-feeling associations of the user. Differing responses based on differing states of mind of the user may eventually average out, resulting in a more predictable and neutral set of image/feeling associations. Such regular content-feeling association assessment is to address the concern that any single assessment alone may be strongly affected by the user's emotional state of mind at the time when such assessment is performed on him/her as discussed above. The content-feeling association so identified can be used to recommend or retrieve content when the user's emotional state lies within a normal or neutral range.

In the example of FIG. 1, the user library 126 embedded in a computer readable medium, which in operation, maintains for each user a set of content-feeling associations, the associated emotional states, and the time of assessments. Once a script of content has been generated and presented to a user, the content is also stored in the user library 116 together with the content-feeling associations and the emotional states as part of the user history. If the user optionally provides feedback on the content, such feedback may also be included in the user library 126.

In the example of FIG. 1, the content recommendation component 106 of the content engine 118 accesses, browses, selects, and retrieves from content library 124 a script of content comprising a set of content items with “best tagged” psychoactive properties and/or a color profile based on the current assessment of the user's emotional state and content-feeling associations. In addition, one or more of content previously presented to the user, the prior assessment of the content-feeling associations, and emotional state of the user may be retrieved from the user library 126 and be taken into account by the content recommendation component 106 in order to find the content items that have the “right kind” of psychotherapeutic effect or purpose on the specific user. By utilizing the assessment of the user's emotional state and content-feeling associations prior to delivering the psychoactive content to the specific user, the content recommendation component 106 is able to identify and recommend content that reflects and meets the user's emotional need at the time to improve the effectiveness and utility of the content. For a non-limiting example, a sample music clip might be selected to be included in the content because it was encoded to bring cheer to a user with an issue of sadness.

While the system 100 depicted in FIG. 1 is in operation, the content engine 102 identifies one or more psychoactive properties of each content item in content library 124, wherein such properties can include inherent properties of the content items as well as their color profiles, if the content items are images. The content items in the content library 126 are then tagged, categorized, and organized based on their identified psychoactive properties. The user assessment engine 110 assesses content-feeling associations on a per user basis to determine what types of content items induce what types of feelings/reactions from a specific user by a non-limiting example, iteratively presenting the user with a set of images preceded by one or more questions regarding the user's feeling towards the images via the user interaction engine 116. In addition, the user assessment engine 110 may also assess the current emotional state of the user. The assessed content-feeling associations and the emotional state of the specific user can be stored and maintained in user library 126. Once the content items in content library 124 are categorized by their psychoactive properties and the content-feeling associations and/emotional state are assessed for the user, the content engine 102 identifies, selects, and retrieves one or more content items from the content library 124 to compose a (script of) content that are most likely to meet the current emotional and psychological needs of the user, or achieve the desired emotional impact on the user. The content engine 102 then provides the user-specific psychoactive content to the user interaction engine 116, which then provides the content to the user in MME form. The user-specific psychoactive content presented to the user may also be stored and maintained in user library 126 for future reference. Optionally, the user may also provide feedback to the content presented via the user interaction engine 116, wherein such feedback may also be stored and maintained in the user library 126 for future reference.

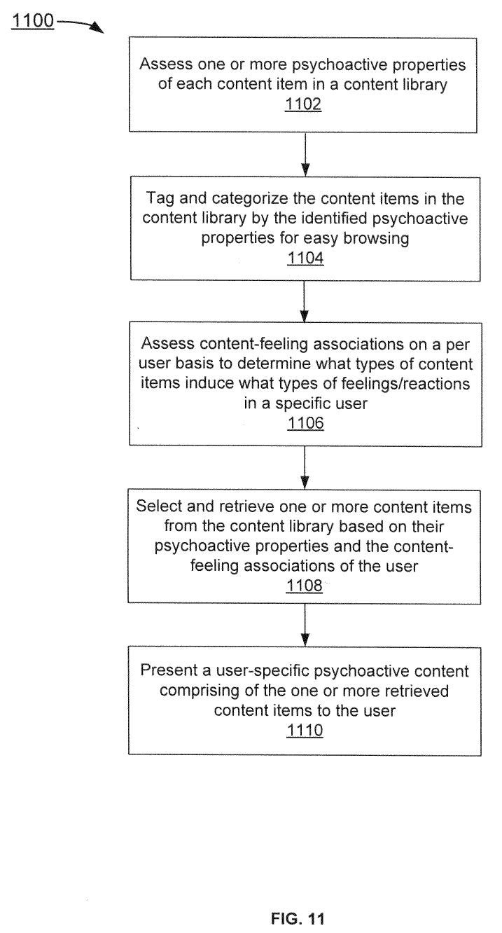

FIG. 11 depicts a flowchart of an example of a process to support identifying and providing user-specific psychoactive content. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 11, the flowchart 1100 starts at block 1102 where one or more psychoactive properties of each content item in a content library are assessed. Here the psychoactive properties of the content items include both their inherent properties of the content items as well as their color profiles if the content items are images.

In the example of FIG. 11, the flowchart 1100 continues block 1104 where the content items in the content library are tagged and categorized by the identified psychoactive properties for easy browsing. Here, a content item may be tagged under multiple psychoactive properties for easy identification and retrieval.

In the example of FIG. 11, the flowchart 1100 continues block 1106 where content-feeling associations are assessed on a per user basis to determine what types of content items induce what types of feelings/reactions from a specific user. Here, the assessment process may iteratively presents the user with sets of images and one or more preceding questions to assess the user's emotional reactions to the images presented.

In the example of FIG. 11, the flowchart 1100 continues block 1108 where one or more content items are selected and retrieved from the content library based on their psychoactive properties and the content-feeling associations of the user. Such content are selected based on their ability to meet the current emotional and psychological needs of the user or to achieve a desired emotional impact on the user.

In the example of FIG. 11, the flowchart 1100 ends at block 1110 where a user-specific psychoactive content comprising of the one or more retrieved content items is presented to the user in proper forms. Here, the proper forms refer the format, color, font, ordering, and other factors affecting the presentation of the content.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject, matter has been provided for the purposes of illustration and description. It is not intended to be exhaustive or to limit the claimed subject matter to the precise forms disclosed. Many modifications and variations will be apparent to the practitioner skilled in the art. Particularly, while the concept “interface” is used in the embodiments of the systems and methods described above, it will be evident that such concept can be interchangeably used with equivalent software concepts such as, class, method, type, module, component, bean, module, object model, process, thread, and other suitable concepts. While the concept “component” is used in the embodiments of the systems and methods described above, it will be evident that such concept can be interchangeably used with equivalent concepts such as class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system, comprising:
a user assessment engine, which in operation, assesses content-feeling associations on a per user basis to determine what types of content items induce what types of feelings/reactions from a specific user;
a content engine, which in operation,
identifies one or more psychoactive properties of each content item in a content library;
selects and retrieves one or more content items from the content library based on the psychoactive properties of the content items and the content-feeling associations of the user;
a user interaction engine, which in operation, presents a the user-specific psychoactive content including the one or more content items to the user.

2. The system of claim 1, wherein:
each of the one or more content items is a text, an image, an audio, a video item, or other type of content item from which the user can be emotionally impacted.

3. The system of claim 1, wherein:
the content library stores and maintains the content items as well as definitions, tags, and source of the content items.

4. The system of claim 1, wherein:
the content engine tags and categorizes the content items in the content library based on their psychoactive properties.

5. The system of claim 4, wherein:
the content engine tags a single content item with multiple psychoactive properties.

6. The system of claim 1, wherein:
the content engine identifies one or more inherent properties of a content item.

7. The system of claim 6, wherein:
each of one or more the inherent psychoactive properties of the content item is one of: abstractness, energy, scale, time of day, urbanity, season, facial expression, of depiction of behavior.

8. The system of claim 1, wherein:
the content engine algorithmically detects a color profile and/or brightness of an image in the content library.

9. The system of claim 8, wherein:
the content engine uses the detected color profile as an index to a table of predefined “dark” and “bright” color values to select images from the content library for desired effect on the user.

10. The system of claim 8, wherein:
the content engine algorithmically detects the color profile of the image using k-means clustering.

11. The system of claim 8, wherein:
the content engine identifies a color name for each RGB value in the color profile.

12. The system of claim 1, wherein:
the user assessment engine iteratively presents the user with one or more content items, preceded by one or more questions for the purpose of soliciting information needed to assess the content-feeling associations of the user toward content items with certain psychoactive properties.

13. The system of claim 1, wherein:
the user assessment engine assesses current emotional state of the user before the content is retrieved and presented to the user.

14. The system of claim 13, wherein:
the user assessment engine initiates one or more questions to the user for the purpose of soliciting and gathering at least part of the information necessary to assess the user's emotional state.

15. The system of claim 13, wherein:
the user assessment engine presents a visual representation of emotions to the user and enables the user to select his/her active emotional state.

16. The system of claim 1, wherein:
the user assessment engine performs the content-feeling associations assessments on a regular basis to average out differing responses based on differing emotional states of the user.

17. The system of claim 1, further comprising:
a user library embedded in a computer readable medium, which in operation, stores and maintains the content-feeling associations and/or the emotional state of the specific user.

18. The system of claim 17, wherein:
the user library further stores and maintains the user-specific psychoactive content presented to the user and/or feedback on the presented content by the user.

19. The system of claim 1, wherein:
the content engine browses, selects, and retrieves the one or more content items with “best tagged” psychoactive properties and/or a color profile based on the current assessment of emotional state and content-feeling associations of the user.

20. The system of claim 19, wherein:
the content engine takes into account one or more of: content previously presented to the user, the prior assessment of the content-feeling associations, and emotional state of the user in order to find the content items having the desired psychotherapeutic effect or purpose on the user.

21. A computer-implemented method, comprising:
assessing one or more psychoactive properties of each content item in a content library;
assessing content-feeling associations on a per user basis to determine what types of content items induce what types of feelings or reactions from a specific user;
selecting and retrieving one or more content items from the content library based on their psychoactive properties and the content-feeling associations of the user;
presenting a user-specific psychoactive content comprising of the one or more retrieved content items to the user.

22. The method of claim 21, further comprising:
storing and maintaining the content items as well as definitions, tags, and source of the content items.

23. The method of claim 21, further comprising:
tagging and categorizing the content items in the content library by the identified psychoactive properties for easy browsing.

24. The method of claim 23, further comprising:
tagging a single content item with multiple psychoactive properties.

25. The method of claim 21, further comprising:
identifying one or more inherent properties of a content item.

26. The method of claim 21, further comprising:
detecting a color profile and/or brightness of an image in the content library algorithmically.

27. The method of claim 26, further comprising:
using the detected color profile as an index to a table of predefined “dark” and “bright” color values to select images from the content library for desired effect on the user.

28. The method of claim 26, further comprising:
detecting the color profile and/or brightness of an image in the content library using k-means clustering.

29. The method of claim 26, further comprising:
identifying a color name for the each RGB value in the color profile.

30. The method of claim 21, further comprising:
presenting the user iteratively with one or more content items, preceded by one or more questions for the purpose of soliciting information needed to assess the content-feeling associations of the user toward content items with certain psychoactive properties.

31. The method of claim 21, further comprising:
assessing current emotional state of the user before the content is retrieved and presented to the user.

32. The method of claim 31, further comprising:
initiating one or more questions to the user for the purpose of soliciting and gathering at least part of the information necessary to assess the user's emotional state.

33. The method of claim 31, further comprising:
presenting a visual representation of emotions to the user and enables the user to select his/her active emotional state.

34. The method of claim 21, further comprising:
performing the content-feeling associations assessments on a regular basis to average out differing responses based on differing emotional states of the user.

35. The method of claim 21, further comprising:
storing and maintaining the content-feeling associations and/or emotional state of the specific user.

36. The method of claim 21, further comprising:
storing and maintaining the user-specific psychoactive content presented to the user and/or feedback on the presented content by the user.

37. The method of claim 21, further comprising:
browsing, selecting, and retrieving the one or more content items with “best tagged” psychoactive properties and/or a color profile based on the current assessment of emotional state and content-feeling associations of the user.

38. The method of claim 37, further comprising:
taking into account one or more of: content previously presented to the user, the prior assessment of the content-feeling associations, and emotional state of the user in order to find the content items having the desired psychotherapeutic effect or purpose on the user.

39. A system, comprising:
means for assessing one or more psychoactive properties of each content item in a content library;
means for assessing content-feeling associations on a per user basis to determine what types of content items induce what types of feelings or reactions from a specific user;
means for selecting and retrieving one or more content items from the content library based on their psychoactive properties and the content-feeling associations of the user;
means for presenting a user-specific psychoactive content comprising of the one or more retrieved content items to the user.

40. A machine readable medium having software instructions stored thereon that when executed cause a system to:
assess one or more psychoactive properties of each content item in a content library;
assess content-feeling associations on a per user basis to determine what types of content items induce what types of feelings or reactions from a specific user;
select and retrieve one or more content items from the content library based on their psychoactive properties and the content-feeling associations of the user;
present a user-specific psychoactive content comprising of the one or more retrieved content items to the user.
